(19) United States
(12) Patent Application Publication
(10) Pub. No.: US 2023/0391308 A1
(43) Pub. Date: Dec. 7, 2023

(54) ACTUATION DEVICE FOR A BRAKE SYSTEM

(71) Applicant: Robert Bosch GmbH, Stuttgart (DE)

(72) Inventor: Matthias Greiner, Simmozheim (DE)

(21) Appl. No.: 18/254,048

(22) PCT Filed: Jan. 25, 2022
(86) PCT No.: PCT/EP2022/051575

§ 371 Date: May 23, 2023

(30) Foreign Application Priority Data
Feb. 5, 2021 (DE) 10 2021 201 079.2

(51) Int. Cl. B60T 13/74; B60T 11/18

(52) U.S. Cl. CPC B60T 13/745; B60T 11/18

(57) ABSTRACT

An actuation device for a brake system. The actuation device includes an electric motor which is designed to drive a drive shaft mounted rotatably about an axis of rotation, a housing, and a main brake cylinder which is rigidly connected to the housing, wherein at least one hydraulic piston is displaceably mounted in the main brake cylinder. The drive shaft is coupled to the hydraulic piston such that the hydraulic piston can be displaced by rotation of the drive shaft. The electric motor is arranged in the housing. The rigid connection of the main brake cylinder to the housing is provided at least in part by the drive shaft.

### FIELD

The present invention relates to an actuation device for a brake system, having an electric motor which is designed to drive a drive shaft mounted rotatably about an axis of rotation, a housing, and a main brake cylinder which is rigidly connected to the housing, wherein at least one hydraulic piston is displaceably mounted in the main brake cylinder, and wherein the drive shaft is coupled to the hydraulic piston such that the hydraulic piston can be displaced by rotation of the drive shaft.

The present invention also relates to a brake system having such an actuation device.

### BACKGROUND INFORMATION

A hydraulic brake system of a motor vehicle generally has a plurality of friction brake devices. To actuate the friction brake devices, an actuation device with a main brake cylinder is usually provided, in which at least one hydraulic piston is displaceably mounted. The main brake cylinder is fluidically connected to slave cylinders of the friction brake devices such that the friction brake devices can be actuated by a displacement of the hydraulic piston.

Electromechanical actuation devices are increasingly being used in automotive engineering. An actuation device of this kind is described in PCT Patent Application No. WO 2017 108 228 A1, for example. The actuation device has an electric motor which is designed to drive a drive shaft mounted rotatably about an axis of rotation. The drive shaft is coupled to the hydraulic piston such that the hydraulic piston can be displaced by rotation of the drive shaft. The hydraulic piston is thus displaceable by the electric motor by means of the drive shaft, so that ultimately the friction brake devices can be actuated by the electric motor. The actuation device also has a housing, wherein the main brake cylinder is rigidly connected to the housing. Typically, in conventional electromechanical actuation devices, the electric motor is arranged outside the housing to which the main brake cylinder is rigidly connected.

### SUMMARY

An actuation device according to the present invention may have the advantage that the actuation device is particularly compact and thus saves installation space. According to the present invention, the electric motor is arranged in the housing, and the rigid connection of the main brake cylinder to the housing is provided at least in part by the drive shaft. According to the present invention, the electric motor is therefore arranged in the housing to which the main brake cylinder is rigidly connected. Due to the arrangement in the housing, the electric motor is protected by the housing, and therefore an additional motor housing can be dispensed with. The electric motor is preferably designed without a motor housing. In addition to saving installation space for the actuation device, this also saves costs. According to the present invention, the main brake cylinder is rigidly connected to the housing or rigidly fastened to the housing. A rigid connection between two bodies is to be understood as a connection which does not allow any relative movement of the bodies relative to one another. In this respect, the rigid connection of the main brake cylinder to the housing is designed, for example, to transmit both axial forces and radial forces. If the terms “axial” and “radial” are used in the disclosure, these terms relate to the axis of rotation of the drive shaft unless a different reference for the terms is expressly disclosed. An axial force is therefore to be understood as a force which is oriented parallel to the axis of rotation. A radial force is accordingly to be understood as a force which is oriented perpendicular to the axis of rotation. Preferably, the hydraulic piston is displaceable along a displacement axis which is oriented parallel to the axis of rotation of the drive shaft. According to the present invention, the rigid connection of the housing to the main brake cylinder is provided or brought about at least in part by the drive shaft. If, for example, an axial force is applied to the main brake cylinder, this axial force is transmitted at least in part by means of the drive shaft to the housing. Since the rigid connection of the housing to the main brake cylinder is provided at least in part by the drive shaft, other elements by which the rigid connection is usually provided in part in conventional actuation devices can be omitted. This also results in the installation space-saving design of the actuation device according to the present invention.

According to an example embodiment of the present invention, preferably, the actuation device has a first bearing which is designed to transmit axial forces and has a first bearing ring and a second bearing ring, wherein the first bearing ring is rigidly connected to the main brake cylinder, and wherein the second bearing ring is rigidly connected to the drive shaft. The rigid connection of the housing to the main brake cylinder is thus provided at least in part by the first bearing. If an axial force is applied to the main brake cylinder, this axial force is transmitted to the drive shaft by means of the first bearing ring and the second bearing ring. By means of the first bearing, sufficiently high axial forces can be transmitted to the drive shaft despite the rotatable mounting of the drive shaft. Preferably, the first bearing ring is an outer bearing ring of the first bearing. Accordingly, the second bearing ring is then an inner bearing ring of the first bearing. Preferably, the second bearing ring is connected to the drive shaft by a press fit. Preferably, the second bearing ring is connected to a first end portion of the drive shaft. Particularly preferably, the first bearing is arranged outside the housing. Accordingly, the drive shaft has a portion which projects out of the housing.

According to an example embodiment of the present invention, preferably, the actuation device has a second bearing which is designed to transmit axial forces and has a third bearing ring and a fourth bearing ring, wherein the third bearing ring is fixed to the housing, and wherein the fourth bearing ring is rigidly connected to the drive shaft. The rigid connection of the housing to the main brake cylinder is thus provided at least in part by the second bearing. If an axial force is applied to the drive shaft, this axial force is transmitted to the housing by means of the fourth bearing ring and the third bearing ring. By means of the second bearing, sufficiently high axial forces can be transmitted from the drive shaft to the housing despite the rotatable mounting of the drive shaft. Preferably, the third bearing ring is an outer bearing ring of the second bearing. Accordingly, the fourth bearing ring is then an inner bearing ring of the second bearing. Preferably, the fourth bearing ring is connected to the drive shaft by a press fit. The fourth bearing ring is preferably connected to a second end portion of the drive shaft. If the first bearing is connected to the drive shaft in the region of the first end portion of the drive shaft, and the second bearing is connected to the drive shaft in the region of the second end portion of the drive shaft, the electric motor is arranged axially between the first bearing on one side and the second bearing on the other side. A stable rotatable mounting of the drive shaft by means of the two bearings is achieved thereby.

According to a preferred embodiment of the present invention, it is provided that the first bearing and/or the second bearing are designed as rolling element bearings, in particular tapered roller bearings. Firstly, such bearings enable low-friction rotation of the drive shaft. Secondly, sufficiently high axial forces can be transmitted by such bearings. With regard to the transmission of high axial forces, the design of the bearings as tapered roller bearings is particularly advantageous.

According to an example embodiment of the present invention, preferably, the housing has a cup-shaped recess, wherein the second bearing is arranged in the recess. Due to the provision of the recess and the arrangement of the second bearing in the recess, a particularly stable connection of the third bearing ring to the housing can be achieved. Preferably, the third bearing ring is pressed into the recess. The third bearing ring is therefore connected to the housing by a press fit which acts between a lateral wall of the recess and a lateral wall of the third bearing ring.

According to an example embodiment of the present invention, preferably, the main brake cylinder has a connection flange, wherein the first bearing ring is rigidly connected to the connection flange. A stable connection of the main brake cylinder to the housing can be provided by the connection flange. The connection flange preferably has an axial hole in which the first bearing is arranged. Preferably, the first bearing ring is connected to the connection flange by a press fit which acts between a lateral wall of the axial hole and a lateral wall of the first bearing ring.

The actuation device preferably has a control unit for controlling the electric motor, wherein the connection flange is arranged axially between the electric motor on one side and the control unit on the other side. This arrangement of the control unit is particularly advantageous. Firstly, the control unit is located in spatial proximity to the electric motor in such an arrangement, as a result of which an electrical connection of the control unit to the electric motor is technically easily possible. Secondly, the control unit is cooled by the connection flange during operation owing to the spatial proximity to the connection flange. Preferably, the control unit, in particular a control unit housing of the control unit, bears axially directly against the connection flange.

According to a preferred embodiment of the present invention, the control unit is electrically connected by at least one electrical line to a motor winding of the electric motor, wherein the connection flange has an axial hole through which the line extends. The line thus runs through the connection flange. As a result, the line is protected by the connection flange, and the electrical connection of the control unit to the motor winding is simplified in that the line does not have to be routed around the connection flange.

Preferably, according to an example embodiment of the present invention, the actuation device has at least one locking ring which engages radially in a circumferential groove of the drive shaft in order to secure the drive shaft axially. This increases the magnitude of the axial forces which can be transmitted by the drive shaft. Preferably, the locking ring bears axially directly against the second bearing ring of the first bearing or the fourth bearing ring of the second bearing. Particularly preferably, the locking ring is arranged on a side of the first bearing facing away from the second bearing and bears axially directly against the second bearing ring of the first bearing. Preferably, the actuation device then has a further locking ring which engages radially into a further circumferential groove of the drive shaft in order to secure the drive shaft axially, is arranged on a side of the second bearing facing away from the first bearing and bears axially directly against the fourth bearing ring of the second bearing.

According to an example embodiment of the present invention, preferably, the actuation device has an actuation element which is displaceably guided in the housing, wherein the guidance of the actuation element is provided at least in part by the electric motor. The actuation element is understood to mean an element which is coupled to the hydraulic piston such that the hydraulic piston is displaceable by a displacement of the actuation element. The drive shaft is preferably coupled to the hydraulic piston by means of the actuation element. Since the guidance of the actuation element is provided at least in part by the electric motor, at most a small number of other components is necessary for guiding the actuation element.

According to an example embodiment of the present invention, preferably, the actuation device has an anti-rotation plate which is rigidly connected to the actuation element, wherein an element of the electric motor that is fixed to the housing has a guide projection which engages radially in a cut-out in the anti-rotation plate in order to guide the actuation element. This achieves secure guidance of the actuation element. Preferably, the guide projection has a coating by means of which friction between the guide projection and the anti-rotation plate is reduced. According to a further exemplary embodiment, the anti-rotation plate has a guide projection which engages radially in a cut-out in the element of the electric motor that is fixed to the housing in order to guide the actuation element.

According to an example embodiment of the present invention, preferably, the actuation device has a pull rod, wherein the rigid connection of the housing to the main brake cylinder and the guidance of the actuation element are each provided in part by the pull rod. Due to the provision of the pull rod, the stability of the rigid connection of the housing to the main brake cylinder and the stability of the guidance of the actuation element are increased. Preferably, the actuation device has exactly one pull rod designed as described above.

According to a preferred embodiment of the present invention, a longitudinal center axis of the main brake cylinder, a longitudinal center axis of the pull rod and the axis of rotation of the drive shaft are oriented parallel to one another and lie in the same plane, wherein the main brake cylinder is arranged radially between the pull rod on one side and the drive shaft on the other side. By means of such a configuration, axial forces acting on the main brake cylinder are advantageously divided between the pull rod and the drive shaft.

According to an example embodiment of the present invention, the brake system includes the actuation device according to the present invention. This also results in the advantages already mentioned. Further preferred features and combinations of features are disclosed herein. The brake system preferably has at least one friction brake device which is connected fluidically to the main brake cylinder such that the friction brake device can be actuated by displacement of the hydraulic piston.

The present invention is explained in more detail below with reference to the figures.

### BRIEF DESCRIPTION OF THE DRAWINGS

FIG. 1 shows a sectional illustration of an actuation device for a brake system, according to an example embodiment of the present invention.

FIG. 2 shows a plan view of the actuation device, according to an example embodiment of the present invention.

### DETAILED DESCRIPTION OF EXAMPLE EMBODIMENTS

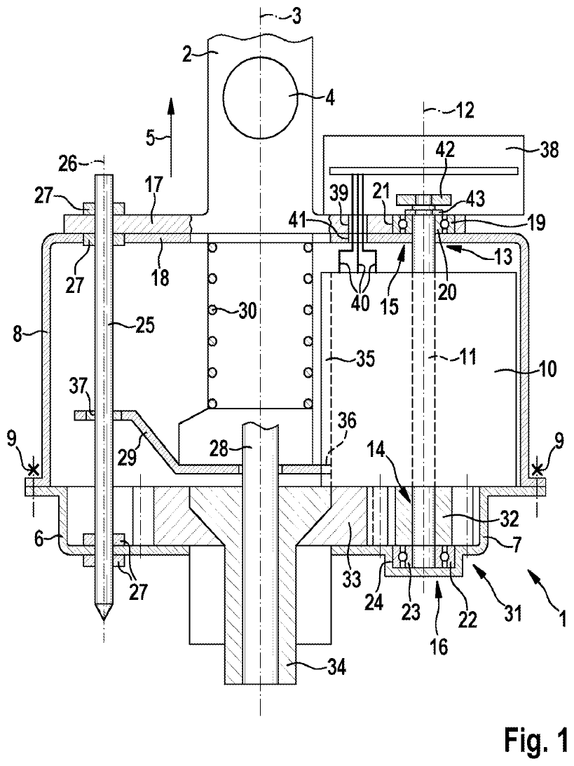

FIG. 1 shows a sectional illustration of an actuation device 1 for a hydraulic brake system of a motor vehicle. The actuation device 1 has a main brake cylinder 2. At least one hydraulic piston (not shown) is mounted axially displaceably along a displacement axis 3 in the main brake cylinder 2. In the present case, the main brake cylinder 2 is a tandem main brake cylinder 2. Accordingly, two hydraulic pistons are mounted displaceably axially one behind the other in the main brake cylinder 2. The displacement axis 3 corresponds to the longitudinal center axis 3 of the main brake cylinder 2. If the actuation device 1 is mounted as part of the brake system in the motor vehicle, the main brake cylinder 2 is connected by a plurality of hydraulic connections, of which only one hydraulic connection 4 is shown 9 Substitute Specification in FIG. 1, to slave cylinders of friction brake devices of the brake system such that the friction brake devices can be actuated by displacement of the hydraulic pistons into an actuation device 5.

The actuation device 1 also has a housing 6. The housing 6 is of multi-part design. In the present case, the housing 6 has a base body 7 and a cover 8. The base body 7 and the cover 8 are rigidly connected to one another by fastening means 9.

The actuation device 1 also has an electric motor 10 which is arranged in the housing 6 so as to be fixed to the housing. The electric motor 10 is designed to drive a drive shaft 11 which is mounted rotatably about an axis of rotation 12. The axis of rotation 12 is oriented parallel to the displacement axis 3. The drive shaft 11 projects axially beyond the electric motor 10 on both sides. In this respect, the drive shaft 11 has a first end portion 13, which is arranged axially on one side of the electric motor 10, and a second end portion 14, which is arranged axially on the other side of the electric motor 10. A first bearing 15 and a second bearing 16 are provided for rotatably mounting the drive shaft 11. The first bearing 15 supports the first end portion 13 of the drive shaft 11. The second bearing 16 supports the second end portion 14 of the drive shaft 11. In the present case, the bearings 15 and 16 are designed as rolling element bearings 15 and 16.

The main brake cylinder 2 has a connection flange 17. The connection flange 17 bears axially against an outer side of a wall 18 of the cover 8, which is oriented perpendicular to the axis of rotation 12. The main brake cylinder 2 is rigidly connected to the housing 6 or rigidly fastened to the housing. In this respect, there is a connection acting between the main brake cylinder 2 on one side and the housing 6 on the other side, by means of which connection both axial forces and radial forces can be transmitted. If, for example, an axial force acting in actuation direction 5 is applied to the main brake cylinder 2, this axial force is transmitted to the housing 6.

The rigid connection of the main brake cylinder 2 to the housing 6 is provided in part by the drive shaft 11. The first bearing 15 and the second bearing 16 are designed to transmit both axial forces and radial forces. For this purpose, the first bearing 15 has a first bearing ring 19 and a second bearing ring 20, wherein the bearing rings 19 and 20 are rotatable relative to one another. The first bearing ring 19 is rigidly connected to the main brake cylinder 2. In the present case, the first bearing ring 19 is pressed into a first axial hole 21 in the connection flange 17. The second bearing ring 20 is rigidly connected to the drive shaft 11. In the present case, the drive shaft 11 is pressed into the second bearing ring 20. The second bearing 16 has a third bearing ring 22 and a fourth bearing ring 23, wherein the bearing rings 22 and 23 are rotatable relative to one another. The third bearing ring 22 is rigidly connected to the housing 6. In the present case, the third bearing ring 22 is pressed into a cup-shaped recess 24 in the base body 7 of the housing 6. The fourth bearing ring 23 is rigidly connected to the drive shaft 11. In the present case, the drive shaft 11 is pressed into the fourth bearing ring 23. Thus, if an axial force acting in the actuation device 5 is applied to the main brake cylinder 2, this axial force is transmitted by the first bearing ring 19, the second bearing ring 20, the drive shaft 11, the fourth bearing ring 23 and the third bearing ring 22 to the housing 6.

The actuation device 1 also has a pull rod 25. The pull rod 25 is arranged such that a longitudinal center axis 26 of the pull rod 25 is oriented parallel to the axis of rotation 12. The rigid connection of the main brake cylinder 2 to the housing 6 is also provided in part by the pull rod 25. For this purpose, the pull rod 25 extends axially through the housing 6 and the connection flange 17 and is fixed axially to the housing 6 and the connection flange 17 by axial stops 27.

The actuation device 1 also has an axially displaceably guided actuation element 28. The actuation element 28 is coupled to the hydraulic piston such that the hydraulic pistons are displaceable by displacement of the actuation element 28. An anti-rotation plate 29 is rigidly connected to the actuation element 28 and is thus displaceable together with the actuation element 28. In addition, the actuation device 1 has a restoring spring 30, which is supported axially on the main brake cylinder 2 on one side and on the actuation element 28 or on an element rigidly connected to the actuation element 28 on the other side.

The drive shaft 11 is operatively connected to the actuation element 28 such that the actuation element 28 is displaceable by rotation of the drive shaft 11. In this respect, the hydraulic pistons are displaceable by the electric motor 10. For this purpose, the actuation device 1 has a gear device 31. The gear device 31 has a first gearwheel 32 which is connected for conjoint rotation to the drive shaft 11. The first gearwheel 32 is arranged axially between the electric motor 10 on one side and the second bearing 16 on the other side. The first gearwheel 32 is designed to drive a spindle nut 34 of the gear device 31 by means of at least one further gearwheel 33 of the gear device 31. An external thread of the actuation element 28 meshes with an internal thread of the spindle nut 34 such that the actuation element 28 is displaceable by rotation of the spindle nut 34.

The guidance of the actuation element 28 is provided in part by the electric motor 10. In the present case, an element of the electric motor 10 that is fixed to the housing, for example a carrier of the electric motor 10, has a guide projection 35 which extends in the axial direction. The anti-rotation plate 30 has a cut-out 36 which extends axially through the anti-rotation plate 29. The guide projection 35 engages radially in the cut-out 36 in order to guide the actuation element 28. The guide projection 35 has a coating (not shown in FIG. 1), by means of which friction between the guide projection 35 and the anti-rotation plate 30 is reduced. According to a further exemplary embodiment, the anti-rotation plate 30 has a guide projection which engages radially in a cut-out, extending in the axial direction, in the electric motor 10 in order to guide the actuation element 28.

The guidance of the actuation element 28 is additionally provided in part by the pull rod 25. For this purpose, the anti-rotation plate 30 has an axial hole 37 through which the pull rod 25 extends axially in order to guide the actuation element 28.

The actuation device 1 also has a control unit 38 for controlling the electric motor 10. For example, the control unit 38 is designed to control the electric motor 10 on the basis of a sensor signal of an actuation sensor (not shown) of the actuation device 1. The connection flange 17 is arranged axially between the electric motor 10 on one side and the control unit 38 on the other side. The control unit 38 bears axially directly against the connection flange 16.

The connection flange 17 has a second axial hole 39, which is axially aligned with an axial hole 41 in the cover 8. The control unit 38 is electrically connected to a motor winding of the electric motor 10 by means of a plurality of electrical lines 40. The electrical lines 40 extend through the second axial hole 39 in the connection flange 17 and through the axial hole 41 in the cover 8.

In order to monitor a rotational angle of the drive shaft 11, a magnetic element 42 is provided, which is connected for conjoint rotation to a free end of the first end portion 13 of the drive shaft 11. In addition, a receiver (not shown) is provided, which is designed to detect a magnetic field generated by the magnetic element 42. For this purpose, the receiver lies radially or axially opposite the magnetic element 42, for example.

A locking ring 43 is provided in order to secure the drive shaft 11 axially. The locking ring 43 engages radially in a circumferential groove of the drive shaft 11. The locking ring 43 is arranged axially between the magnetic element 42 on one side and the first bearing 15 on the other side and bears axially directly against the second bearing ring 20. According to a further exemplary embodiment, the drive shaft 11 projects axially beyond the second bearing 16. According to this exemplary embodiment, a further locking ring is preferably provided, which is arranged on a side of the second bearing 16 facing away from the first bearing 15 and bears axially directly against the fourth bearing ring 23. Preferably, the further locking ring engages radially in a further circumferential groove of the drive shaft 11.

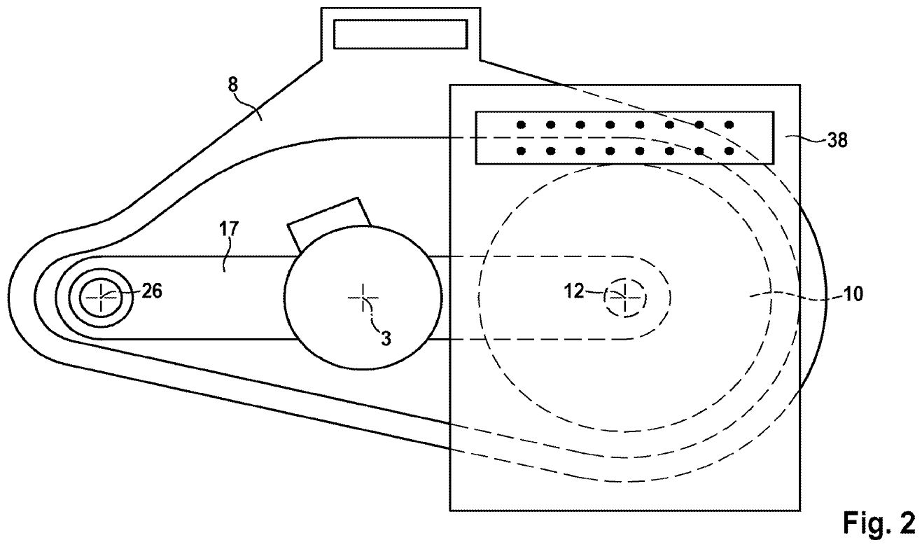

FIG. 2 shows a plan view of the actuation device 1. As can be seen in FIG. 2, the main brake cylinder 2, the pull rod 25 and the drive shaft 11 are arranged such that the longitudinal center axis 26 of the pull rod 25, the longitudinal center axis 3 of the main brake cylinder 2, and the axis of rotation 12 of the drive shaft 11 lie in the same plane. The main brake cylinder 2 is arranged radially between the pull rod 25 and the drive shaft 11. In addition, the longitudinal center axis 26 of the pull rod 25 and the axis of rotation 12 of the drive shaft 11 are spaced equally far from the longitudinal center axis 3 of the main brake cylinder 2 in the radial direction.

Since the drive shaft 11 in part provides the rigid connection of the main brake cylinder 2 to the housing 6, and since the electric motor 10 in part provides the guidance of the actuation element 28, a further pull rod which would typically provide the rigid connection and the guidance together with the pull rod 25 can be dispensed with. As a result, the actuation device 1 is saves space overall, as can be seen in FIG. 2.

1-14. (canceled)

15. An actuation device for a brake system, comprising:
an electric motor configured to drive a drive shaft mounted rotatably about an axis of rotation;
a housing; and
a main brake cylinder rigidly connected to the housing, wherein at least one hydraulic piston is displaceably mounted in the main brake cylinder, and wherein the drive shaft is coupled to the hydraulic piston such that the hydraulic piston can be displaced by rotation of the drive shaft;
wherein the electric motor is arranged in the housing, and the rigid connection of the main brake cylinder to the housing is provided at least in part by the drive shaft.

16. The actuation device according to claim 15, further comprising:
a first bearing configured to transmit axial forces and having a first bearing ring and a second bearing ring, wherein the first bearing ring is rigidly connected to the main brake cylinder, and the second bearing ring is rigidly connected to the drive shaft.

17. The actuation device according to claim 16, further comprising:
a second bearing configured to transmit axial forces and having a third bearing ring and a fourth bearing ring, wherein the third bearing ring is fixed to the housing, and the fourth bearing ring is rigidly connected to the drive shaft.

18. The actuation device according to claim 17, wherein the first bearing and/or the second bearing include tapered roller bearings.

19. The actuation device according to claim 17, wherein the housing has a cup-shaped recess, wherein the second bearing is arranged in the recess.

20. The actuation device according to claim 16, wherein the main brake cylinder has a connection flange, and the first bearing ring is rigidly connected to the connection flange.

21. The actuation device according to claim 20, further comprising:
a control unit configured to control the electric motor, wherein the connection flange is arranged axially between the electric motor on one side and the control unit on the other side.

22. The actuation device according to claim 21, wherein the control unit is electrically connected by at least one electrical line to a motor winding of the electric motor, wherein the connection flange has an axial hole through which the line extends.

23. The actuation device according to claim 15, further comprising:
at least one locking ring which engages radially in a circumferential groove of the drive shaft to secure the drive shaft axially.

24. The actuation device according to claim 15, further comprising:
an actuation element which is displaceably guided in the housing, wherein the guidance of the actuation element is provided at least in part by the electric motor.

25. The actuation device according to claim 24, further comprising:
an anti-rotation plate which is rigidly connected to the actuation element, wherein an element of the electric motor that is fixed to the housing has a guide projection which engages radially in a cut-out in the anti-rotation plate to guide the actuation element.

26. The actuation device according to claim 24, wherein the actuation device has a pull rod, wherein the rigid connection of the housing to the main brake cylinder and the guidance of the actuation element are each provided in part by the pull rod.

27. The actuation device according to claim 26, wherein a longitudinal center axis of the main brake cylinder, a longitudinal center axis of the pull rod, and the axis of rotation of the drive shaft are oriented parallel to one another and lie in the same plane, wherein the main brake cylinder is arranged radially between the pull rod on one side and the drive shaft on the other side.

28. A brake system, comprising:
an actuation device, including:
an electric motor configured to drive a drive shaft mounted rotatably about an axis of rotation,
a housing, and
a main brake cylinder rigidly connected to the housing, wherein at least one hydraulic piston is displaceably mounted in the main brake cylinder, and wherein the drive shaft is coupled to the hydraulic piston such that the hydraulic piston can be displaced by rotation of the drive shaft,
wherein the electric motor is arranged in the housing, and the rigid connection of the main brake cylinder to the housing is provided at least in part by the drive shaft.
